(19) United States
(12) Patent Application Publication
(10) Pub. No.: US 2013/0014009 A1
(43) Pub. Date: Jan. 10, 2013

(54) ELECTRONIC DOCUMENT PREPARING APPARATUS, ELECTRONIC DOCUMENT PREPARING SYSTEM COMPRISING SAME AND CONTROL METHOD THEREOF AND ELECTRONIC DOCUMENT READING SYSTEM AND CONTROL METHOD THEREOF

(76) Inventors: Tae Woo Kim, Seoul (KR); Nam Su Kim, Seoul (KR)

(21) Appl. No.: 13/634,443

(22) PCT Filed: Dec. 7, 2011
(86) PCT No.: PCT/KR2011/009418

§ 371 Date: Sep. 12, 2012

Related U.S. Application Data
(60) Provisional application No. 61/421,716, filed on Dec. 10, 2010.

(30) Foreign Application Priority Data
Feb. 7, 2011 (KR) 1020110010773

(51) Int. Cl. G06F 17/00

(52) U.S. Cl. 715/255

(57) ABSTRACT

Provided is an electronic document preparing apparatus which provides an intuitive user interface to enable a user to prepare an electronic document in an easy and convenient manner, and which stores and analyzes a signal input by the user during an electronic document preparing process and an electronic document reading process so as to identify a user behavior pattern. Also provided are electronic documents preparing system including the electronic document preparing apparatus and a control method thereof, and an electronic document reading system and a control method thereof.

### TECHNICAL FIELD

The present invention relates to an interactive electronic document creating device that may easily and conveniently create an interactive electronic document to be used as a book by recording information such as letters or images on an electronic medium, may store a user input signal generated when the interactive electronic document is created or used, and may recognize a user action pattern by analyzing the user input signal, a system including the interactive electronic document creating device, a method of controlling the system, an interactive electronic document reading system, and a method of controlling the interactive electronic document reading system.

### BACKGROUND ART

An electronic book, i.e., an e-book, is a digital book that can be used like a book and contains information such as letters or images recorded on an electronic medium. That is, the electronic book generally refers to a digital book formed by recording written contents, which have been published or which may be published as a book, in the form of digital data on an electronic recording medium or a storage device, so that the recorded contents can be read, viewed, or listened to by using a computer or a portable terminal via a wired or wireless information communication network.

Since the Nippon Electric Company (NEC) in Japan first commercialized an electronic book, the electronic book industry has n rapidly developed. Now, electronic books have improved screen resolution, various editing functions, or the like, so that a user may turn a page by a click, may have a memo function, may increase or reduce a text, and may retrieve and download documents from Internet book shops or libraries. Also, the electronic book is highly inexpensive compared to a paper book, time may be easily purchased on-line to save time, and only a required part thereof may be separately purchased if necessary. A user may view a moving picture document or listens to music while he/she reads a book, or may store the electronic book in a personal digital assistant (PDA) or a portable terminal, and thus, may easily search for a desired book at any time and any where. For a publishing company, an electronic book is advantageous in that manufacturing and distribution costs may be saved, a stock load may be reduced, and book contents may be easily updated. For a reader, the reader may purchase an electronic book on-line without having to go to a book shop, so that the reader may save time. Also, the reader may view a moving picture document or may listen to music while he/she reads a book, and may easily search for a desired book at any time and any where.

### DETAILED DESCRIPTION OF THE INVENTION

### Technical Problem

The present invention provides an interactive electronic document creating device that may allow a user to easily and conveniently create an interactive electronic document by providing an intuitive user interface, may store user input signals is generated during creation and reading procedures of the interactive electronic document, and may recognize a user action pattern by analyzing the user input signals, a system including the interactive electronic document creating device, a method of controlling the system, an interactive electronic document reading system, and a method of controlling the interactive electronic document reading system.

### Technical Solution

According to an aspect of the present invention, there is provided an interactive electronic document creating device for creating an interactive electronic document, the interactive electronic document creating device including a user interface unit for receiving a user input signal; an object adding unit for adding an object to the interactive electronic document; an action and status adding unit for adding an action and a status to the object of the interactive electronic document; and a control unit for controlling the addition of the object, the addition of the action, and the addition of the status with respect to the interactive electronic document, in response to an input signal received by the user interface unit.

The interactive electronic document creating device may further include a database for storing information of the object that is added to the interactive electronic document, and the action and the status which are added to the object.

The interactive electronic document creating device may further include a page adding unit for controlling addition of a new page to the interactive electronic document.

The database may further store at least one of a consecutive number of a page generated by the page adding unit, previous and next pages of the page, information of an object included in the page, and an action and a status which are applied to the object included in the page.

The interactive electronic document creating device may import the object, the action, and the status from a separate file.

The interactive electronic document creating device may further include a preview generating unit for previously checking the object disposed in the interactive electronic document and the action or the status, which is applied to the object.

The interactive electronic document creating device may further include a log storage unit for storing an interactive electronic document creation log.

The interactive electronic document creation log may indicate a record of various types of input signals that are input to the user interface unit while the interactive electronic document is being created.

The interactive electronic document creation log may include at least one of the number of generated pages, a creation time of each of the pages, the number of times that each object, each action, and each status are selected, and a method of adding each object, each action, and each status.

The control unit may control the object to be added to the interactive electronic document, in response to a drag-and-drop signal or a touch-and-drag signal which is received by the user interface unit.

The control unit may control the action and the status to be added to the object, in response to a drag-and-drop signal or a touch-and-drag signal which is received by the user interface unit.

The control unit may control a size and a position of the object in the interactive electronic document.

The interactive electronic document creating device may include at least one of a tablet personal computer (tablet PC), a mobile telephone, a smart phone, a telephone, a PC, and a personal digital assistant (PDA).

According to another aspect of the present invention, there is provided a system including an interactive electronic document creating device having a structure including the aforementioned elements; and an application server that is connected to the interactive electronic document creating device via a communication network and that receives and stores an interactive electronic document creation log stored in the interactive electronic document creating device.

The interactive electronic document creation log may indicate a record of various types of input signals that are input to the user interface unit while the interactive electronic document is being created.

The interactive electronic document creation log may include at least one of the number of generated pages, a creation time of each of the pages, the number of times that each object, each action, and each status are selected, and a method of adding each object, each action, and each status.

The application server may analyze a user's input pattern and a user's preference with respect to the object, the action, and the status.

According to another aspect of the present invention, there is provided a method of controlling an interactive electronic document creating system, the method including operations of executing an interactive electronic document creating application; creating an interactive electronic document by using the interactive electronic document creating application; and storing an interactive electronic document creation log that is generated while the interactive electronic document is being created.

The operation of creating the interactive electronic document may include operations of adding an object to the interactive electronic document, in response to a received user input signal; adding an action and a status to the object, in response to a received user input signal; and storing the object, the action, and the status.

The object may be added to the interactive electronic document in response to a drag-and-drop signal or a touch-and-drag signal which is received by a user interface unit.

The action and the status may be added to the object in response to a drag-and-drop signal or a touch-and-drag signal which is received by a user interface unit.

The interactive electronic document creation log may indicate a record of various types of input signals that are input to the user interface unit while the interactive electronic document is being created.

The interactive electronic document creation log may include at least one of the number of generated pages, a creation time of each of the pages, the number of times that each object, each action, and each status are selected, and a method of adding each object, each action, and each status.

The method may further include an operation of transmitting the interactive electronic document creation log to an application server.

The method may further include an operation of analyzing, by the application server, a user's input pattern and a user's preference with respect to the object, the action, and the status from the interactive electronic document creation log.

According to another aspect of the present invention, there is provided an interactive electronic document reading system including an interactive electronic document reader for reading a created interactive electronic document, and storing an interactive electronic document reading log that is generated in the reading; and an application server that is connected to the interactive electronic document reader via a to communication network and that receives and stores the interactive electronic document reading log stored in the interactive electronic document reader.

The interactive electronic document reading log may indicate a record of various types of input signals that are input to a user interface unit while the interactive electronic document is being read.

The interactive electronic document reading log may include at least one of coordinates of a user-touched position on the interactive electronic document reader, an object disposed at the user-touched position, actions and statuses which are performed when the object is executed, a number of a read page, a background and background music, and a time period in which a user works on each page.

The application server may analyze a user's input pattern and a user's preference with respect to an object, an action, and a status from the interactive electronic document reading log.

According to another aspect of the present invention, there is provided a method of controlling an interactive electronic document reading system, the method including operations of executing an interactive electronic document reading application; reading an interactive electronic document by using the interactive electronic document reading application; and storing an interactive electronic document reading log that is generated while the interactive electronic document is being read.

The interactive electronic document reading log may indicate a record of various types of input signals that are input to a user interface unit while the interactive electronic document is being read.

The interactive electronic document reading log may include at least one of coordinates of a user-touched position on an interactive electronic document reader, an object disposed at the user-touched position, actions and statuses which are performed when the object is executed, a number of a read page, a background and background music, and a time period in which a user works on each page.

The method may further include an operation of transmitting the interactive electronic document reading log to an application server.

The method may further include an operation of analyzing, by the application server, a user's input pattern and a user's preference with respect to an object, an action, and a status from the interactive electronic document reading log.

### Advantageous Effects

According to the one or more embodiments of the present invention, a user may easily and conveniently create an interactive electronic document. Further, user input signals that are generated in interactive electronic document creation and reading procedures are stored and analyzed to recognize a user action pattern, so that it is possible to easily form user-customized interactive electronic document creating and reading devices.

### DESCRIPTION OF THE DRAWINGS

FIG. 1A is a block diagram showing a logic device according to an embodiment of the present invention.

FIG. 1B illustrates another example of a computing system.

FIG. 1C illustrates components that may be employed in system configurations enabling systems and technical effects of one or more embodiments of the present invention, including wireless access points to which client devices communicate.

FIG. 2 is a diagram of a server in an implementation consistent with the principles of the disclosure to achieve the desired technical effects and transformation, according to an embodiment of the present invention.

FIG. 3 is a diagram of a master system suitable for use in an implementation consistent with the principles of the disclosure to achieve the desired technical effects and transformation, according to an embodiment of the present invention.

FIG. 4 illustrates a networked computing environment including a server in communication with client computers via a communications network, according to an embodiment of the present invention. FIG. 5 is a block diagram of a system for creating an interactive electronic document, and an interactive electronic document reading system, according to embodiments of the present invention.

FIG. 6 is a block diagram of an interactive electronic document creating device in the system of FIG. 5.

FIG. 7 is a flowchart of a method of controlling the system of FIG. 5, according to an embodiment of the present invention.

FIG. 8 is a flowchart for describing in detail the creation of the interactive electronic document in the method of FIG. 7.

FIGS. 9A through 9S illustrate execution screens of the interactive electronic to document creating application to perform the operations in the creation of the interactive electronic document in FIG. 8.

FIG. 10 is a flowchart of a method of controlling the interactive electronic document reading system, according to an embodiment of the present invention.

### BEST MODE

I. Computing Systems

The systems and methods described herein rely on a variety of computer systems, networks, and/or digital devices. In order to fully appreciate how the system operates, an understanding of suitable computing systems is useful. The systems and methods disclosed herein are enabled as a result of an application executed via a suitable computing system.

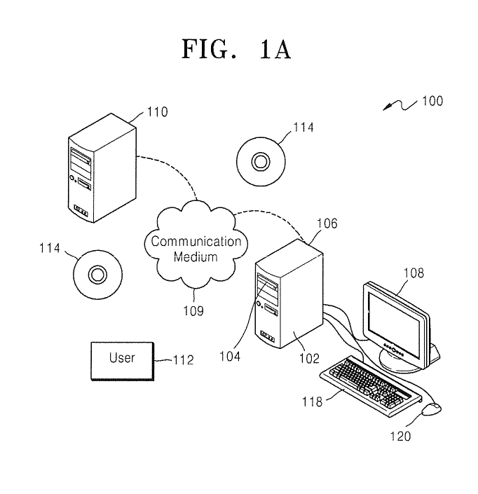

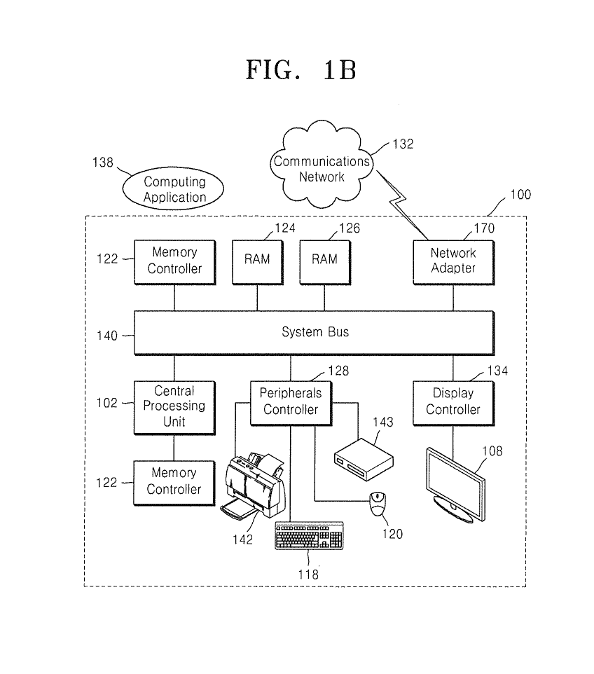

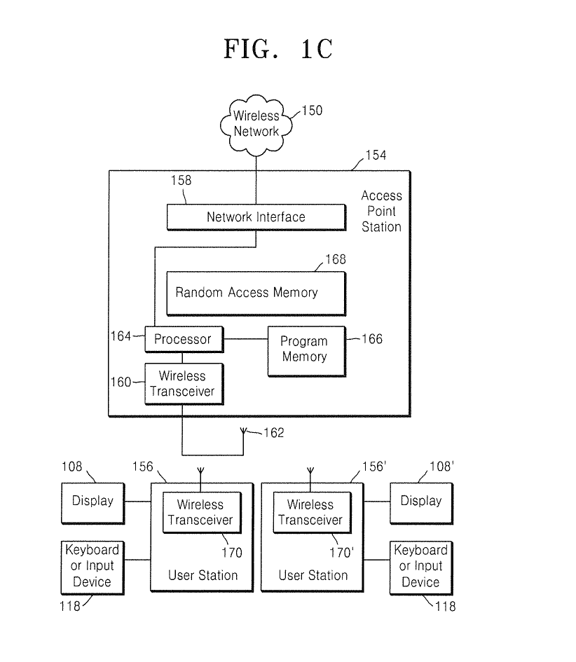

FIG. 1A is a block diagram showing a logic device according to an embodiment of the present invention. A computer system (or digital device) 100, which may be understood as a logic apparatus adapted and configured to read instructions from a media 114 and/or a network port 106, is connectable to a server 110, and has fixed media 116. The computer system 100 may also be connected to the Internet or an intranet. The system includes a central processing unit (CPU) 102, disk drives 104, optional input devices, illustrated as a keyboard 118 and/or a mouse 120 and an optional monitor 108. Data communication may be achieved through, for example, a communication means 109 connected to a server 110 at a local or a remote location. The communication means 109 may include any suitable means for transmitting and/or receiving data. For example, the communication means 109 may be a network connection, wireless connection, or Internet connection. It is envisioned that data relating to the present invention may be transmitted over such networks or connections. The computer system may be adapted to communicate with a participant and/or a device used by a participant. The computer system is adaptable to communicate with other computers over the Internet, or with computers via a server.

FIG. 1B illustrates another example of the computer system 100. The computer system 100 is capable of executing a variety of computing applications 138, including a computing applet, a computing program, or other instructions for operating on the computer system 100 to perform at least one function, operation, and/or procedure. The computer system 100 is controllable by computer readable storage means for tangibly storing computer readable instructions. The computer readable storage means adapted to tangibly store computer readable instructions may contain instructions for the computer system 100 for storing and accessing the computer readable storage means to read the instructions stored thereon. Such software may be executed in a CPU 102 to cause the computer system 100 to perform desired functions. In many known computer servers, workstations and personal computers, the CPU 102 is implemented by micro-electronic chips CPUs called microprocessors. Optionally, a co-processor, distinct from the main CPU 102, may be provided to perform additional functions or to assist the CPU 102. The CPU 102 may be connected to the co-processor through interconnection. One common type of the coprocessor is a floating-point coprocessor, also called a numeric or math coprocessor, which is designed to perform numeric calculations faster and better than the general-purpose CPU 102.

As generally known, a computer readable means stores computer data, including a computer program code that is executable by a computer, in a machine readable form. As a non-limiting example, a computer readable means may include a computer readable storage means, for tangible or fixed storage of data, or a communication means, for transient interpretation of code-containing signals. The computer readable storage means, as used herein, refers to a physical or tangible storage (as opposed to signals) and includes without limitation volatile and non-volatile, removable and non-removable storage means implemented in any method or technology for the tangible storage of information such as computer-readable instructions, data structures, program modules or other data. The computer readable storage means includes, but is not limited to, a RAM, a ROM, an EPROM, an EEPROM, a flash memory or other solid state memory technology, a CD-ROM, a DVD, or other optical storage, magnetic cassettes, magnetic tape, magnetic disk storage or other magnetic storage devices, or any other physical or material means which may be used to tangibly store the desired information or data or instructions and which may be accessed by a computer or processor.

In operation, the CPU 102 fetches, decodes, and executes instructions, and transfers information to and from other resources via the computer's main data-transfer path, a system bus 140. The system bus 140 connects the components in the computer system 100 and defines a means for a data exchange. Memory devices coupled to the system bus 140 include a RAM 124 and a ROM 126. Such memories include circuitry that allows information to be stored and retrieved. In general, the ROM 126 contains stored data that cannot be modified. Data stored in the RAM 124 may be read or changed by the CPU 102 or other hardware devices. Access to the RAM 124 and/or the ROM 126 may be controlled by a memory controller 122. The memory controller 122 may provide an address translation function that translates virtual addresses into physical addresses as instructions are being executed.

In addition, the computer system 100 may include a peripherals controller 128 responsible for communicating instructions from the CPU 102 to peripherals such as a printer 142, a keyboard 118, a mouse 120, and a data storage drive 143. A display 108, which is controlled by a display controller 163, is used to display visual output generated by the computer system 100. The visual output may include a text, graphics, moving picture graphics, and a video. The display controller 134 includes electronic components required to generate a video signal that is sent to the display 108. The computer system 100 may include a network adaptor 136 which may be used to connect the computer system 100 to an external communications network 132.

II. Networks and Internet Protocol

As is well understood by one of ordinary skill in the art, the Internet is a worldwide network of computer networks. Today, the Internet is a public and self-sustaining network that is available to many millions of users. The Internet uses a set of communication protocols called Transmission Control Protocol/Internet Protocol (TCP/IP) to connect hosts. The Internet has a communication infrastructure known as the Internet backbone. Access to the Internet backbone is largely controlled by

Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which may be used without departing from the scope of the invention. Each host device on the network has at least one IP address that is its own unique identifier and acts as a connectionless protocol. The connection between terminals during a communication is not continuous. When a user sends or receives data or messages, the data or messages are divided into components known as packets. Every packet is treated as an independent unit of data and is routed to its final destination - but not necessarily via the same path.

The Open System Interconnection (OSI) model was established to standardize transmission between points via the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

In general, the top four layers are used when a message is sent from or to a user and the bottom three layers are used when a message is sent via a device (e.g., an IP host device). The IP host device is any device on the network that is capable of transmitting and receiving IP packets, such as a server, a router or a workstation. Messages destined for some other hosts are not passed up to the upper layers but are forwarded to the other hosts. The layers of the OSI model are listed below. Layer 7 (i.e., the application layer) is a layer at which, e.g., communication partners are identified, a quality of service is identified, user authentication and privacy are considered, constraints on data syntax are identified, and the like. Layer 6 (i.e., the presentation layer) is a layer that, e.g., converts incoming and outgoing data from one presentation format to another, and the like. Layer 5 (i.e., the session layer) is a layer that, e.g., sets up, coordinates, and terminates conversations, exchanges and dialogs between the applications, and the like. Layer-4 (i.e., the transport layer) is a layer that, e.g., manages end-to-end control and error-checking, and the like. Layer-3 (i.e., the network layer) is a layer that, e.g., handles routing and forwarding, and the like. Layer-2 (i.e., the data-link layer) is a layer that, e.g., provides synchronization for the physical level, does bit-stuffing and furnishes transmission protocol knowledge and management, and the like. The Institute of Electrical and Electronics Engineers (IEEE) sub-divides the data-link layer into two further sub-layers, the Media Access Control (MAC) layer that controls the data transfer to and from the physical layer and the Logical Link Control (LLC) layer that interfaces with the network layer and interprets commands and performs error recovery. Layer 1 (i.e., the physical layer) is a layer that, e.g., conveys the bit stream through the network at the physical level. The IEEE sub-divides the physical layer into the Physical Layer Convergence Procedure (PLOP) sub-layer and the Physical Medium Dependent (PMD) sub-layer.

III. Wireless Networks

Wireless networks incorporate a variety of types of mobile devices, such as, e.g., cellular and wireless telephones, personal computers (PCs), laptop computers, wearable computers, cordless phones, pagers, headsets, printers, PDAs, and the like. For example, mobile devices may include digital systems to secure fast wireless transmissions of voice and/or data. Typical mobile devices include some or all of the is following components: a transceiver (for example, a transmitter and a receiver, including a single chip transceiver with an integrated transmitter, a receiver and, if desired, other functions); an antenna; a processor; a display; one or more audio transducers (for example, a speaker or a microphone as in devices for audio communications); an electromagnetic data storage (such as a ROM, a RAM, a digital data storage, etc., such as in devices where data processing is provided); a memory; a flash memory; and/or a full chip set or integrated circuit; interfaces (such as universal serial bus (USB), coder-decoder (CODEC), an universal asynchronous receiver-transmitter (UART), a phase-change memory (PCM), etc.). Other components may be provided without departing from the scope of the invention.

Wireless local area networks (WLANs) in which a mobile user may connect to a LAN through a wireless connection may be employed for wireless communications. Wireless communications may include communications that propagate via electromagnetic waves, such as light, infrared, radio, and microwave. There are a variety of WLAN standards that currently exist, such as Bluetooth®, IEEE 802.11, and the obsolete Home Radio Frequency (HomeRF).

For example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. For example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between Is points in a network. In addition, Multiple Interface Devices (MIDs) may be utilized in some wireless networks. The MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to, Bluetooth devices, Worldwide Interoperability for Microwave Access (WiMAX), Multiple Interface Devices (MIDs), 802.11x devices (IEEE 802.11 devices including, 802.11a, 802.11b and 802.11g devices), HomeRF devices, Wireless Fidelity (Wi-Fi) devices, General Packet Radio Service (GPRS) devices, 3G cellular devices, 2.5G cellular devices, Global System for Mobile Communications (GSM) devices, Enhanced Data for GSM Evolution (EDGE) devices, Time Division Multiple Access (TDMA) type devices, or Code Division Multiple Access (CDMA) type devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks may also involve methods and protocols which are found in mobile IP systems, PCS systems, and other mobile network systems. With respect to a mobile IP, this involves a standard communications protocol created by the Internet Engineering Task Force (IETF). With the mobile IP, mobile device users may move across networks while maintaining their IP Address assigned once. See Request for Comments (RFC) 3344. NB (RFCs are formal documents of the Internet Engineering Task Force (IETF)). The mobile IP enhances an IP and adds a mechanism to forward Internet traffic to mobile devices when connecting outside their home network. The mobile IP assigns each mobile node a home address on its home network and a care-of-address (CoA) that identifies the current location of the device within a network and its subnets. When a device is moved to a different network, the device receives a new CoA.

In basic IP routing (e.g., outside mobile IP), routing mechanisms rely on the assumptions that each network node always has a constant attachment point to the Internet and that each node's IP address identifies the network link it is attached to. In the detailed description, the terminology “node” includes a connection point, which may include a redistribution point or an end point for data transmissions, and which may recognize, process and/or forward communications to other nodes. For example, Internet routers may look at an IP address prefix or the like identifying a device's network. Then, at a network level, routers may look at a set of bits identifying a particular subnet. Then, at a subnet level, routers may look at a set of bits identifying a particular device. With typical mobile IP communications, if a user disconnects a mobile device from the Internet and attempts to reconnect the mobile device at a new subnet, then the mobile device has to be reconfigured with a new IP address, a proper netmask and a default router. In other words, routing protocols would not be able to properly deliver the packets.

FIG. 1C illustrates components that may be employed in system configurations enabling the systems and technical effects of the embodiments of the present invention, including wireless access points to which client devices communicate. In this regard, FIG. 1C shows a wireless network 150 connected to a WLAN 152. The WLAN 152 includes an access point (AP) 154 and a number of user stations 156 and 156′. For example, the network 150 may be the Internet or a corporate data processing network. The access point 154 may be a wireless router, and the user stations 156 and 156′ may be portable computers, personal desk-top computers, PDAs, portable voice-over-IP telephones and/or other devices. The access point 154 has a network interface 158 linked to the network 150, and a wireless transceiver in communication with the user stations 156 and 156′. For example, the wireless transceiver 160 may include an antenna 162 for radio or microwave frequency communication with the user stations 156 and 156′. The access point 154 also has a processor 164, a program memory 166, and a RAM 168. The user station 156 has a wireless transceiver 170 including an antenna 172 for communication with the access point station 154. In a similar fashion, the user station 156′ has a wireless transceiver 170′ and an antenna 172 for communication to the access point 154. A desktop 108 and a key board 118 or input devices may also be provided with the user station.

IV. Media Independent Handover Services

In IEEE P802.21/D.01.09, September 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standards define extensible media access independent mechanisms that enable the optimization of handovers between heterogeneous 802 systems and may facilitate handovers between 802 systems and cellular systems. “The scope of the IEEE 802.21 (Media Independent Handover) standards is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, September 2006, entitled Draft IEEE Standard for Local and Metropolitan Area Networks: Media Independent Handover Services, of which entire contents are incorporated herein into and as part of this patent application. Other IEEE standards or other such protocol standards may be relied on as appropriate or desirable.

FIG. 2 is a diagram of a server 210 in an implementation consistent with the principles of the disclosure to achieve the desired technical effect and transformation, according to an embodiment of the present invention. The server 210 may include a bus 240, a processor 202, a local memory 244, one or more optional input units 246, one or more optional output units 248, a communication interface 232, and a memory interface 222. The bus 240 may include one or more conductors that permit communication among the components of a chunk server 250.

The processor 202 may be any type of a conventional processor or a microprocessor that interprets and executes instructions. The local memory 244 may include a RAM or another type of a dynamic storage device that stores information and instructions for execution by the processor 202 and/or a ROM or another type of a static storage device that stores static information and instructions for use by the processor 202.

The input unit 246 may include one or more conventional mechanisms that permit an operator to input information to a server 110, such as the keyboard 118 (shown in FIG. 1), the mouse 120 (shown in FIG. 1), a pen, voice recognition and/or biometric mechanisms, and the like. The output unit 248 may include one or more conventional mechanisms that output information to the operator, such as the display 134 (shown in FIG. 1), the printer 130 (shown in FIG. 1), a speaker, etc. The communication interface 232 may include any transceiver-like mechanism that enables the chunk server 250 to communicate with other devices and/or systems. For example, the communication interface 232 may include mechanisms for communicating with master and clients.

The memory interface 222 may include a memory controller 122. The memory interface 222 may be connected to one or more memory devices, such as one or more local disks 274, and may control the reading and writing of chunk data to/from the local disks 274. The memory interface 222 may access chunk data using a chunk handle and a byte range within that chunk.

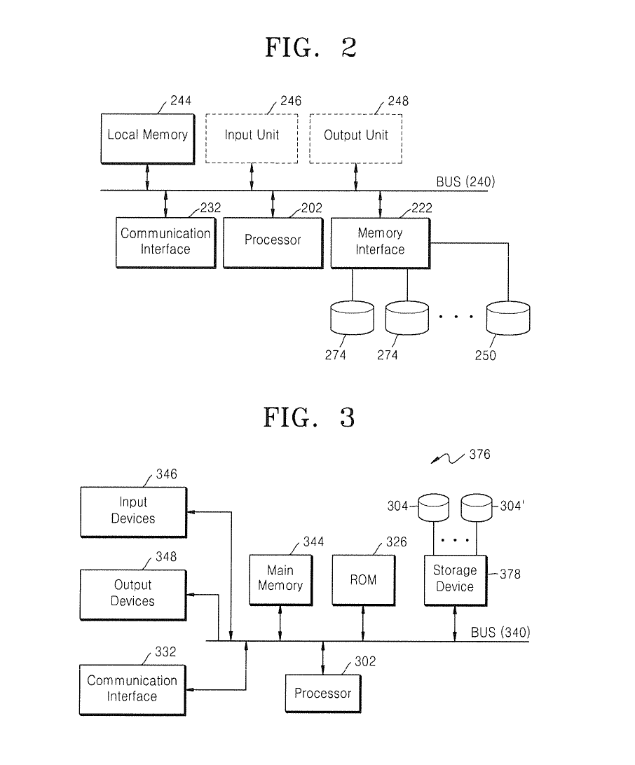

FIG. 3 is a diagram of a master system 376 suitable for use in an implementation consistent with the principles of the disclosure to achieve the desired technical effect and transformation, according to an embodiment of the present invention. The master system 376 may include a bus 340, a processor 302, a main memory 344, a ROM 326, a storage device 378, one or more input devices 346, one or more output devices 348, and a communication interface 332. The bus 340 may include one or more conductors that permit communication among the components of the master system 376.

The processor 302 may be any type of a conventional processor or a microprocessor that interprets and executes instructions. The main memory 344 may be a RAM or another type of a dynamic storage device that stores information and instructions for execution by the processor 302. The ROM 326 may be a conventional ROM device or another type of a static storage device that stores static information and instructions for use by the processor 302. The storage device 378 may be a magnetic and/or optical recording medium and its corresponding drive. For example, the storage device 378 may be one or more local disks that provide a persistent storage.

The input devices 346 used to achieve the desired technical effects and transformation may include one or more conventional mechanisms that permit an operator to input information to the master system 376, such as the keyboard 118 (shown in FIG. 1), the mouse 120 (shown in FIG. 1), a pen, voice recognition and/or biometric mechanisms, and the like. The output devices 348 may include one or more conventional mechanisms that output information to the operator, including the display 108 (shown in FIG. 1), the printer 142 (shown in FIG. 1), a speaker, and the like.

The communication interface 332 may include any transceiver-like mechanism that enables the master system 376 to communicate with other devices and/or systems. For example, the communication interface 332 may include mechanisms for communicating with servers and clients as shown above.

The master system 376 used to achieve the desired technical effects and transformation may maintain file system metadata within one or more computer readable mediums, such as the main memory 344 and/or a storage device.

The computer implemented system provides a storage and delivery base which allows users to exchange services and information openly on the Internet used to achieve the desired technical effects and transformation. A user will be able to operate s both as a consumer and a producer of any and all digital content or information through one or more master system servers.

A user may use a browser to view digital content items and may be connected to a front end server via a network, which is typically the Internet, but may also be any network, including but not limited to any combination of a LAN, a MAN, a WAN, a mobile, wired or wireless network, a private network, or a virtual private network. A very large numbers of users may be in communication with the website at any time. The user may have a variety of different computing devices. Examples of user devices include, but are not limited to, personal computers, digital assistants, personal digital assistants, cellular phones, mobile phones, smart phones or laptop computers.

The browser may include any application that allows users to access web pages on the World Wide Web. Examples of suitable applications include, but are not limited to, Microsoft Internet Explorer®, Netscape Navigator®, Mozilla® Firefox, Apple® Safari or any application adapted to allow access to web pages on the World Wide Web. The browser may also include a video player (e.g., Flash™ from Adobe Systems, Inc.), or any other player adapted for the video file formats used in the video hosting website. Alternatively, videos may be accessed by a standalone program separate from the browser. A user may access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

V. Computer Network Environment

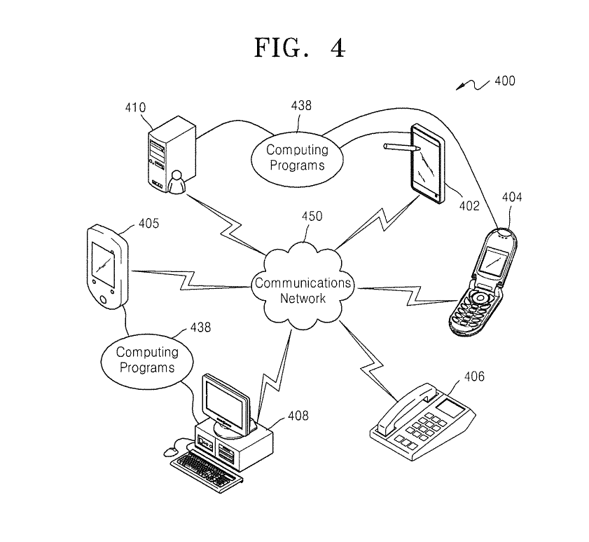

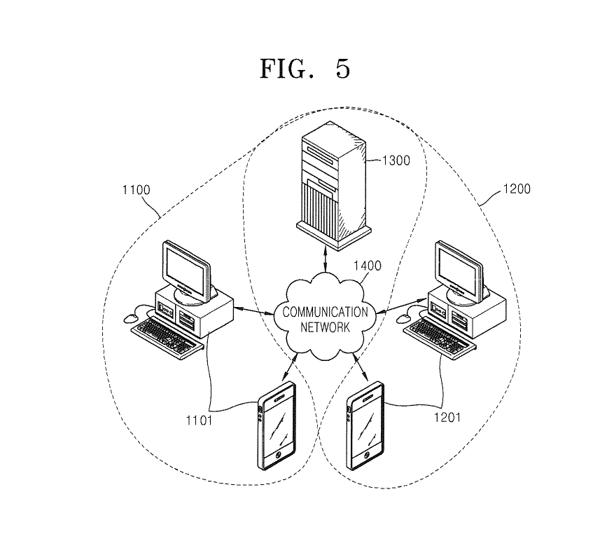

The computer system 100 described above may be deployed as part of a computer network used to achieve the desired technical effects and transformation. In general, the above description for computing environments may be applied both to server computers and client computers deployed in a network environment. FIG. 4 illustrates a networked computing environment 400 with a server in communication with is client computers via a communications network 450, according to an embodiment of the present invention. As shown in FIG. 4, a server 410 may be interconnected via the communications network 450 with a number of client computing environments such as a tablet PC 402, a mobile telephone 404, a smart phone 405, a telephone 406, a PC, and a PDA 408. Here, the communications network 450 may be either of or a combination of a fixed-wire or wireless LAN, WAN, intranet, extranet, peer-to-peer network, virtual private network, the Internet, or other communications network.

For example, in a network environment in which the communications network 450 is the Internet, the server 410 may exchange and handle data with client computing environments via any of a number of known protocols such as hypertext transfer protocol (HTTP), file transfer protocol (FTP), simple object access protocol (SOAP), or wireless application protocol (WAP). Other wireless protocols may be used without departing from the scope of the invention, including, for example Wireless Markup Language (WML), DoCoMo i-mode, and XHTML Basic. Additionally, the networked computing environment 400 may utilize various data security protocols such as secured socket layer (SSL) or pretty good privacy (PGP). Each client computing environment may be equipped with an operating system 438 operable to support one or more computing applications such as a web browser (not shown), or other graphical user interface (not shown), or a mobile desktop environment (not shown) to gain access to the networked computing environment 400.

In operation, a user (not shown) may interact with a computing application running on a client computing environment so as to obtain desired data and/or computing applications. The data and/or computing applications may be stored on the networked computing environment 400 and may be communicated to cooperating users via client computing environments over the communications network 450. The computing applications, which will be described in more detail later, are used to achieve the desired technical effects and transformation set forth. A participating user may request access to specific data and applications housed in whole or in part on the networked computing environment 400. The data may be communicated between client computing environments and server computing environments for processing and storage. The networked computing environment 400 may host computing applications, processes and applets for the generation, authentication, encryption, and communication data and applications and may cooperate with other server computing environments (not shown), third party service providers (not shown), a network attached storage (NAS) and a storage area networks (SAN) to realize application/data transactions.

VI. Software Programs Implementable in the Computing and Network Environments to Achieve a Desired Technical Effect or Transformation

A user launches an interactive electronic document creating application by opening an executable file or by clicking an icon. The interactive electronic document creating application may be executed on any suitable user interface device (e.g., a desktop or a laptop computer operating in Windows, MacOS, or Linux). From the execution, the user is prompted to create a new interactive book. In general, a user may decide a type of book, a resolution, an operating system (e.g., iOS, Android, etc.) and orientation (landscape or portrait) of a screen. Once initial options are set, an editing screen is displayed. Then, the user may dispose desired objects onto the text of the written document, e.g., an e-book, so as to provide scene information for a story. Here, the objects may be either selected from a library of objects or imported by the user.

When a user desires to upload images and/or objects into a library of images/objects, the user may open an import resources dialog box. At that point, the user may select one or more objects that the user wants to import. If the object to be uploaded is packed, such as a photoshop document (PSD), the interactive electronic document creating application may automatically split the object into separate objects. The added resources/objects may then be displayed, for example in a sidebar or tool box on screen. Additionally, the user may manage the objects by creating categories for the objects.

Once the user selects the object to be included in the e-book, the user may then s select an action that will be executed when a target reader triggers the object. Here, the term “trigger” means an action that is automatically performed when a predetermined condition is satisfied or a certain action is performed. Actions and statuses include, but are not limited to, hop, move, vanish, blink, fly, jump, shrink, puff-up (enlarge), waddle, appear, gravity (falling), and user defined. Thus, the user may dispose an object on a scene by dragging and dropping the object to a desired location and may add an action for how that object will behave by dragging and dropping an action type onto the object on the screen.

An end of an action may be triggered by, for example, another action (such as a sequential action) or a termination action. In addition, if the user desires, one or more is actions may be applied to a particular image. For example, an initial action may be a pop-up of an image, and then a next action may be movement across the screen.

Once the user selects the object to be included in the e-book, the user may also select a status for the object. An action is triggered by interaction with an interactive document, while the status is triggered by an internal timer. That is, for example, the status may enable the object to continuously execute actions.

New scenes may be added to the e-book at desired locations throughout the text. In addition, the user may delete or edit any object, action, or scene in the e-book. The objects may be saved and uploaded into devices such as iPad® or Android® tablet device. To load the objects to the tablet may enable a preview of an interactive text. An author may preview an interactive document by launching a desktop application, e.g., Windows, MacOS or Linux. Alternatively, the interactive document may be launched in a preview format on a tablet or mobile device, e.g., iPad®, iPhone®, Android® phone, or Android® tablet).

When in a preview mode, the device may automatically attempt to connect to the desktop application. If software is provided in a multi-user server on a LAN, the user may choose the desktop application to connect. The name of the desktop application may be found on the top of a menu bar. If the desktop application finds another desktop application used on the LAN, a name may be generated by using an incremental number. The desktop application and a preview application on, for example, a mobile device, may be on the same network. This function may be implemented via the Internet.

VII. Interactive Electronic Document Creating Device, a System Including The Interactive Electronic Document Creating Device, a Method of Controlling The System, an Interactive Electronic Document Reading System, and a Method of Controlling The Interactive Electronic Document Reading System

FIG. 5 is a block diagram of a system 1100 for creating an interactive electronic document, and an interactive electronic document reading system 1200, according to embodiments of the present invention.

Referring to FIG. 5, the system 1100 includes one or more interactive electronic document creating devices 1101, an application server 1300 connected to the interactive electronic document creating devices 1101, and a communication network 1400 connecting the interactive electronic document creating devices 1101 and the application server 1300. The interactive electronic document reading system 1200 includes one or more interactive electronic document readers 1201, the application server 1300 connected to the interactive electronic document readers 1201, and the communication network 1400 connecting the interactive electronic document readers 1201 and the application server 1300.

The interactive electronic document creating devices 1101 and the interactive electronic document readers 1201 indicate communication terminals that may use a web service in a wired and wireless communication environment. That is, the interactive electronic document creating device 1101 and the interactive electronic document reader 1201 may be substantially the same elements as the client computing environments such as the tablet PC 402, the mobile telephone 404, the smart phone 405, the telephone 406, the PC, and the PDA 408, which are shown in FIG. 4.

The communication network 1400 connects the interactive electronic document creating devices 1101 to the application server 1300 and/or connects the interactive electronic document readers 1201 to the application server 1300. That is, the communication network 1400 provides a connection path via which the interactive electronic document creating devices 1101 and the interactive electronic document readers 1201 may connect to the application server 1300 and may transmit and receive packet data. That is, the communication network 1400 of FIG. 5 may be substantially the same element as the communications network 450 that is either of or a combination of a fixed-wire or wireless LAN, WAN, intranet, extranet, peer-to-peer network, virtual private network, the Internet, or other communications network, which are shown in FIG. 4.

The application server 1300 is substantially the same element as the server 410 of FIG. 4. In this regard, the application server 1300 is connected to the interactive electronic document creating device 1101 and the interactive electronic document reader 1201 via the communication network 1400, provides an interactive electronic document creating application to the interactive electronic document creating device 1101, provides an interactive electronic document reading application to the interactive electronic document reader 1201, receives a user input log in an interactive electronic document creating procedure from the interactive electronic document creating device 1101, stores the user input log, receives a user input log in an interactive electronic document reading process from the interactive electronic document reader 1201, and stores the user input log.

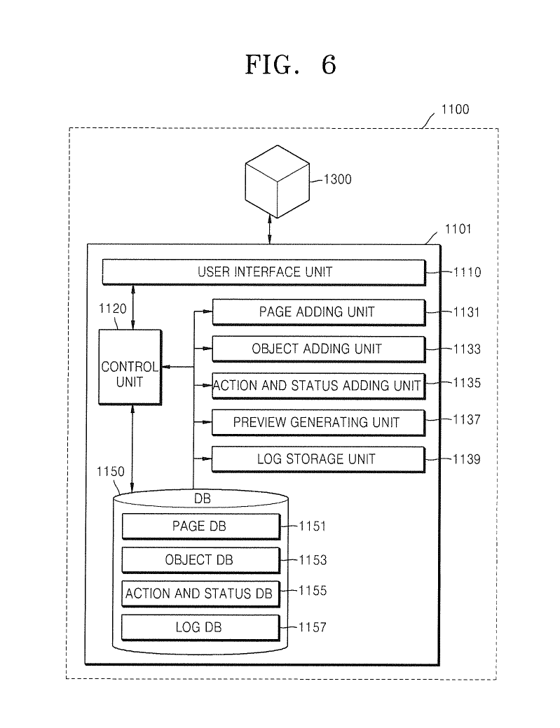

FIG. 6 is a block diagram of the interactive electronic document creating device 1101 in the system 1100 of FIG. 5.

Referring to FIG. 6, the interactive electronic document creating device 1101 includes a user interface unit 1110, a control unit 1120, a page adding unit 1131, an object adding unit 1133, an action and status adding unit 1135, a preview generating unit 1137, a log storage unit 1139, and a database (DB) 1150.

The user interface unit 1110 may receive an input signal from a user and output an output signal to the user and may include the keyboard 118, the mouse 120, or the optional monitor 108 of FIG. 1. Also, the user interface unit 1110 may be a touchscreen of a tablet PC.

In response to a control by the control unit 1120, the page adding unit 1131 adds a new page to an interactive electronic document that is being created. For example, an interactive electronic document such as an e-book may include a plurality of pages. Here, the page adding unit 1131 adds a new page to the interactive electronic document, and thus, allows the control unit 1120 to manage the interactive electronic document for each of the pages. The new page generated by the page adding unit 1131 may be stored in a page DB 1151 of the DB 1150. The page DB 1151 may include a consecutive number of the generated page, previous and next pages of the generated page, information of an object included in the page, actions and statuses applied to the object included in the page, and the like.

In response to a control by the control unit 1120, the object adding unit 1133 adds a new object to the interactive electronic document that is being created. For example, the object may include a plurality of characters appearing in the e-book, or may include a plurality of backgrounds (e.g., trees, rocks, animal, plants, and the like) appearing in the e-book. Here, the object added by the object adding unit 1133 may be stored in an object DB 1153 of the DB 1150 or may be imported by the user. Here, the object that is imported by the user may be included in a package such as a PSD.

In response to a control by the control unit 1120, the action and status adding unit 1135 adds actions and statuses to an object included in the interactive electronic document that is being created. Here, examples of the actions and statuses may include hop, move, vanish, blink, fly, jump, shrink, puff-up (enlarge), waddle, appear, gravity (falling), or the like. Here, the object added by the action and status adding unit 1135 may include actions and statuses stored in an action and status DB 1155 of the DB 1150 or may be imported by the user.

In response to a control by the control unit 1120, the preview generating unit 1137 provides a preview to allow the user to preview an object added to the interactive electronic document that is being created, and to preview an action or a status, which is added to the object. That is, the user may occasionally and easily check disposition and action of the object via the preview while the interactive electronic document is being created.

In response to a control by the control unit 1120, the log storage unit 1139 stores an interactive electronic document creation log in a log DB 1157. Here, the interactive electronic document creation log may indicate a record of various types of input signals that are input from the user while the interactive electronic document is being created. For example, the number of generated pages, a creation time of each page, the number of times that each object, each action, and each status are selected, a method of adding each object, each action, and each status (e.g., a double click, a drag-and-drop, or a touch & drag), or the like may be stored as the interactive electronic document creation log. In addition, the interactive electronic document creation log that is stored in the log DB 1157 by the log storage unit 1139 may be transmitted to the application server 1300, in response to a control by the control unit 1120. Then, the application server 1300 may receive and analyze the interactive electronic document creation log and then may analyze predetermined statistics.

The DB 1150 may include the page DB 1151, the object DB 1153, the action and status DB 1155, and the log DB 1157. Here, the page DB 1151 may store a consecutive number of a generated page, previous and next pages of the generated page, information of an object included in the page, actions and statuses applied to the object included in the page, and the like. The object DB 1153 may store an object such as a character or a background, which appears in the e-book. The action and status DB 1155 may store the actions and statuses applied to the object. The log DB 1157 may store an interactive electronic document creation log indicating a record of various types of input signals that are input from the user while the interactive electronic document is being created. Here, the interactive electronic document creation log may include the number of generated pages, a creation time of each page, the number of times that each object, each action, and each status are selected, a method of adding each object, each action, and each status, and the like.

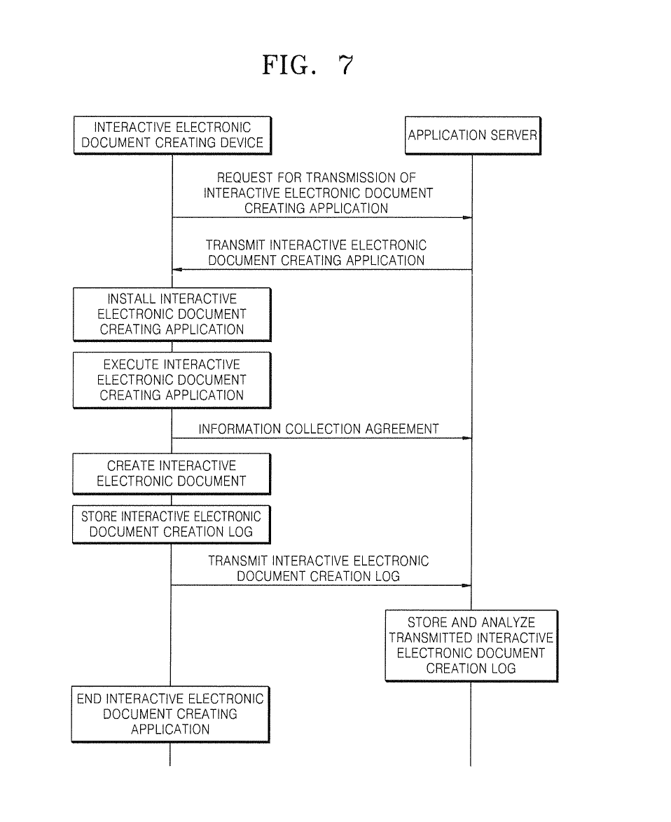

FIG. 7 is a flowchart of a method of controlling the system 1100, according to an embodiment of the present invention. Hereinafter, the method of controlling the system 1100 will be described with reference to FIG. 7.

First, a user who attempts to create an interactive electronic document by using the system 1100 transmits a transmission request for an interactive electronic document creating application to the application server 1300 via the interactive electronic document creating device 1101 such as a tablet PC or a smart phone. Here, although not illustrated in FIG. 7, the user who attempts to create the interactive electronic document may undergo a user authentication procedure before transmitting the transmission request.

In this manner, when the transmission request for the interactive electronic document creating application is transmitted from the interactive electronic document creating device 1101 to the application server 1300, the application server 1300 may determine whether the transmission request satisfies a predetermined condition, and if satisfied, the application server 1300 may transmit the interactive electronic document creating application to the interactive electronic document creating device 1101.

Next, the interactive electronic document creating device 1101 receives and installs the interactive electronic document creating application.

After the interactive electronic document creating application is installed, the user executes the interactive electronic document creating application on a user's interactive electronic document creating device 1101. Then, an interactive electronic document creating program is driven in the interactive electronic document creating device 1101.

The user who executed the interactive electronic document creating application on the interactive electronic document creating device 1101 may transmit an information collection agreement signal to the application server 1300. The information collection agreement signal may include an agreement that the user agrees to provide an interactive electronic document creation log, which is generated in an interactive electronic document creating procedure, to the application server 1300. However, the information collection agreement signal is not necessarily required, so that only a user who wants to provide the interactive electronic document creation log may transmit the information collection agreement signal.

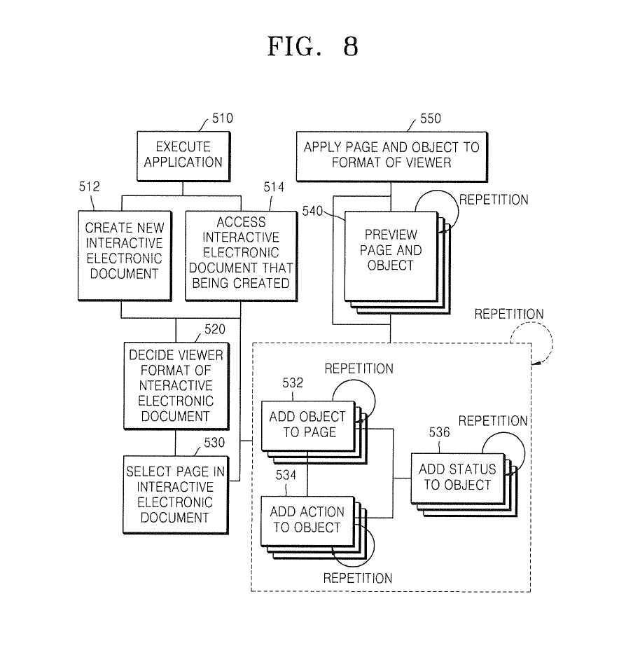

Next, the interactive electronic document creating application is executed on the interactive electronic document creating device 1101, so that an interactive electronic document is actually created. The interactive electronic document creating procedure will be described in detail with reference to FIG. 8 and the like.

Next, when creation of the interactive electronic document is completed, the interactive electronic document creating device 1101 may store an interactive electronic document creation log in the log DB 1157 of the DB 1150. Here, the interactive electronic document creation log may indicate a record of various types of input signals that are input from the user while the interactive electronic document is being created.

Next, the interactive electronic document creation log may be transmitted to the application server 1300. The transmission of the interactive electronic document creation log may be performed only in the interactive electronic document creating device 1101 that has transmitted the information collection agreement signal to the application server 1300.

After the interactive electronic document creation log is transmitted to the application server 1300, the interactive electronic document creating application may be ended, and thus, the interactive electronic document creating procedure may be completed.

The interactive electronic document creation log that is transmitted to the application server 1300 may be stored in and analyzed by the application server 1300. That is, the application server 1300 may store and analyze user input signals such as the number of generated pages, a creation time of each page, the number of times that each object, each action, and each status are selected, a method of adding each object, each action, and each status, and the like, which are included in the interactive electronic document creation log and are generated in the interactive electronic document creating procedure. By doing so, the application server 1300 may analyze an input pattern of each user, an each user's preference for objects, actions, and statuses, or the like.

FIG. 8 is a flowchart for describing in detail the creation of the interactive electronic document in the method of FIG. 7.

Referring to FIG. 8, a user executes the interactive electronic document creating application on the interactive electronic document creating device 1101 (refer to FIG. 6) (operation 510). Once the interactive electronic document creating application is executed, the user may create a new interactive electronic document (operation 512) or may access an interactive electronic document that was being created (operation 514). Here, the user may import various document formats (e.g., .doc, .rtf, .txt. .html, and the like) and may edit the interactive electronic document. Alternatively, a text may be copied and pasted in the interactive electronic document. Then, the user decides a viewing format of the interactive electronic document (operation 520), and selects a target page in the interactive electronic document (operation 530).

Operations below may be performed for each page.

First, one or more objects are added to a selected page (operation 532). In more detail, the object adding unit 1133 (refer to FIG. 6), in response to a control by the control unit 1120 (refer to FIG. 6), adds a new object to an interactive electronic document that is being created. For example, the object may include a plurality of characters appearing in an e-book, or may include a plurality of backgrounds (e.g., trees, rocks, animal, plants, and the like) appearing in the e-book.

Also, one or more actions and statuses are added to the selected page (operations 534 and 536). In more detail, in response to a control by the control unit 1120, the action and status adding unit 1135 (refer to FIG. 6) adds actions and statuses to the object included in the interactive electronic document that is being created. Here, examples of the actions and statuses may include hop, move, vanish, blink, fly, jump, shrink, puff-up (enlarge), waddle, appear, gravity (falling), or the like.

Each of the aforementioned processes may be repeatedly performed several times on each of selected pages. Afterwards, the user may preview an operation of adding the objects, the actions, and the statuses (operation 540). When an operation of editing the page and the objects is completed, the user may apply the page and the objects to a format of a viewer (operation 550).

### Mode of the Invention

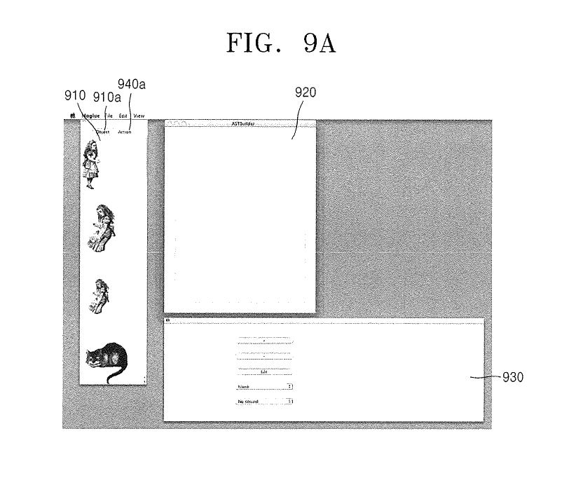

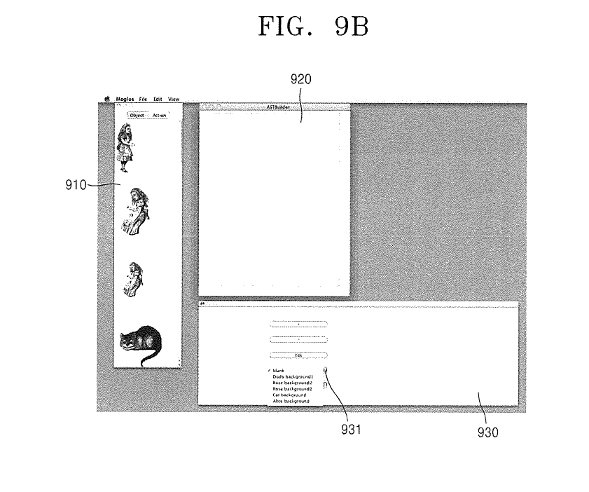

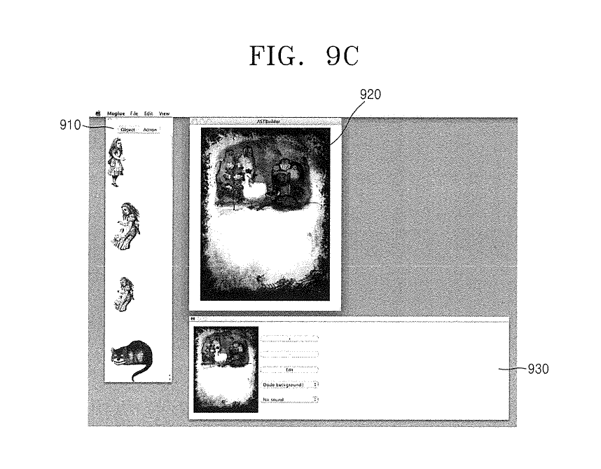

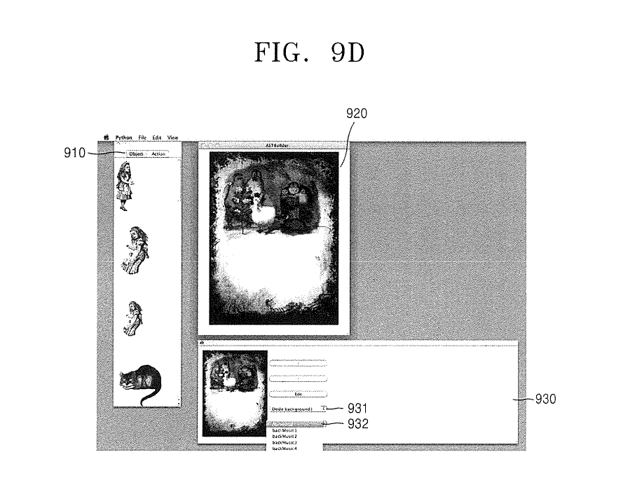

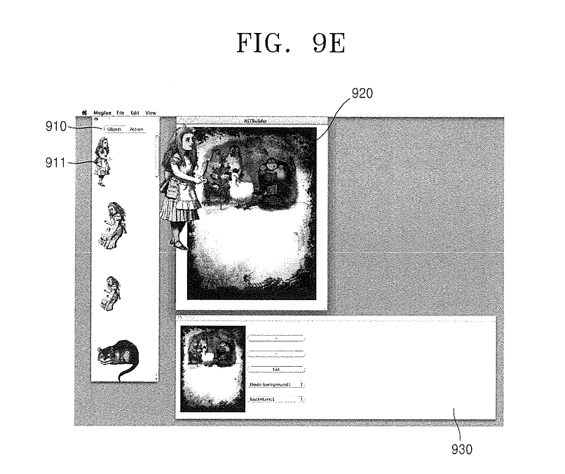

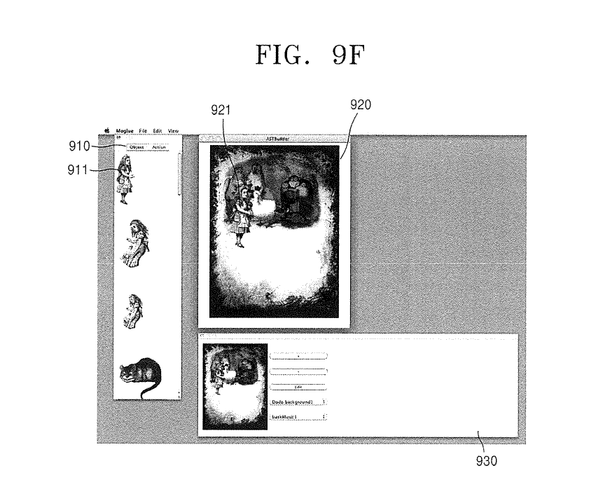

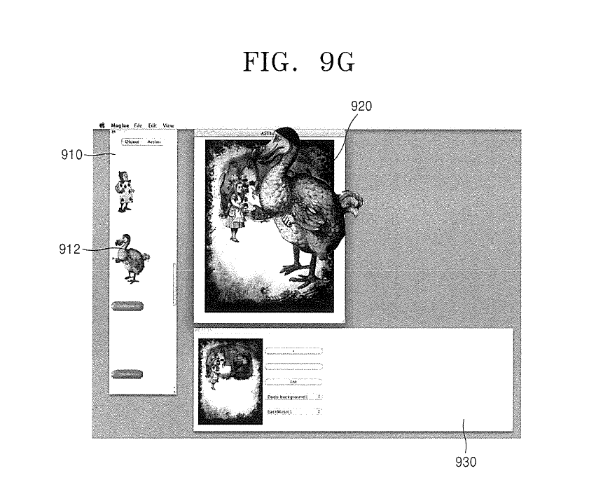

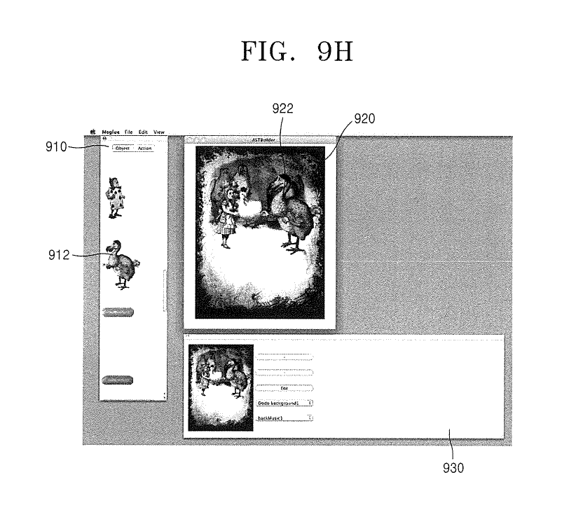

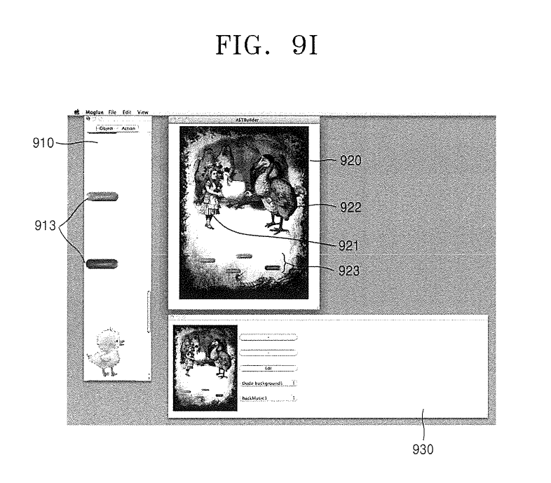

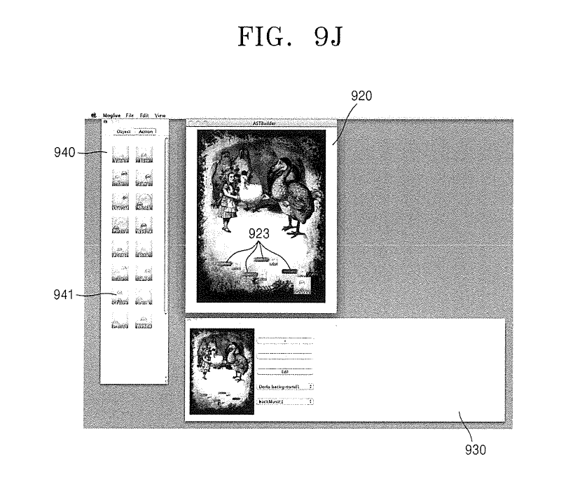

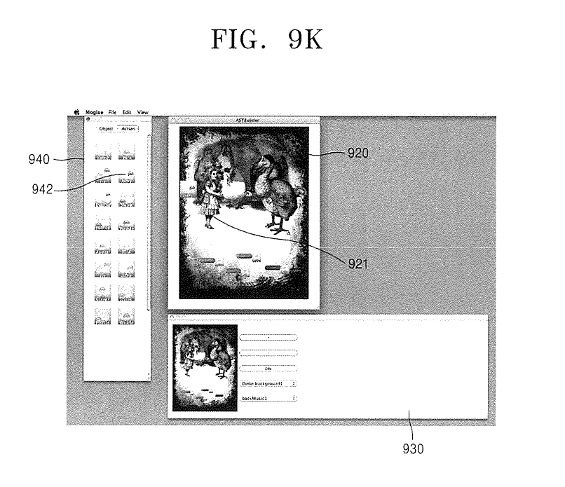

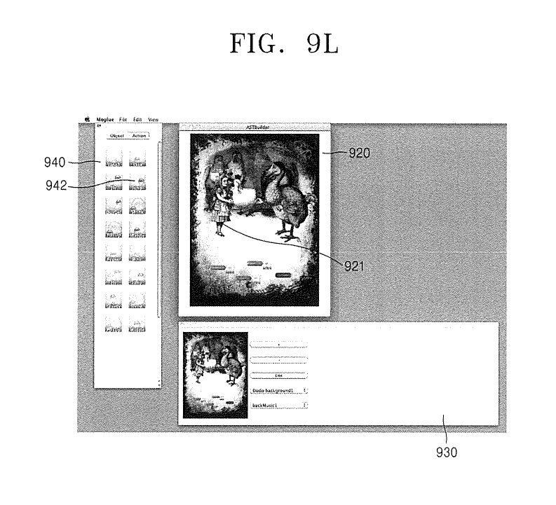

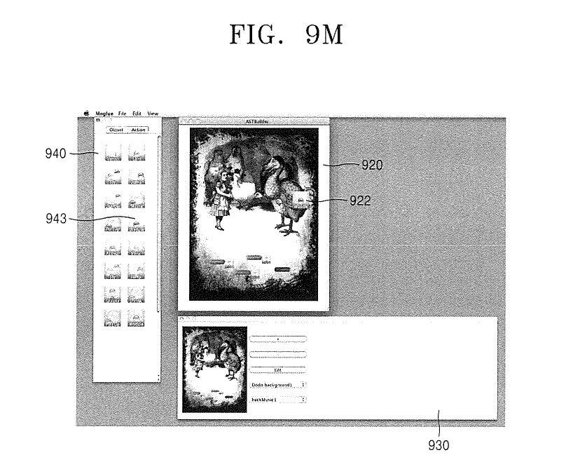

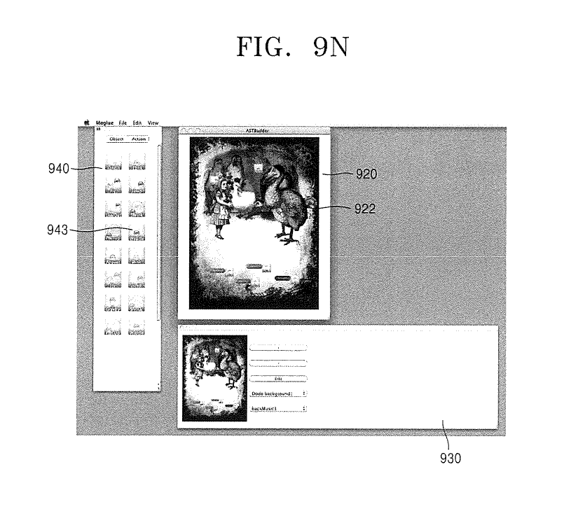

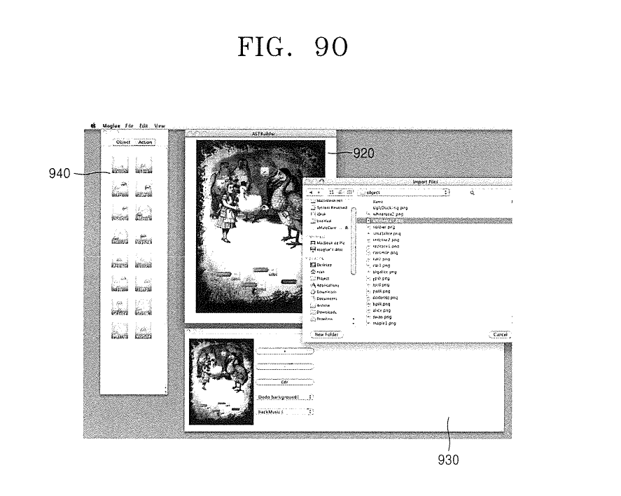

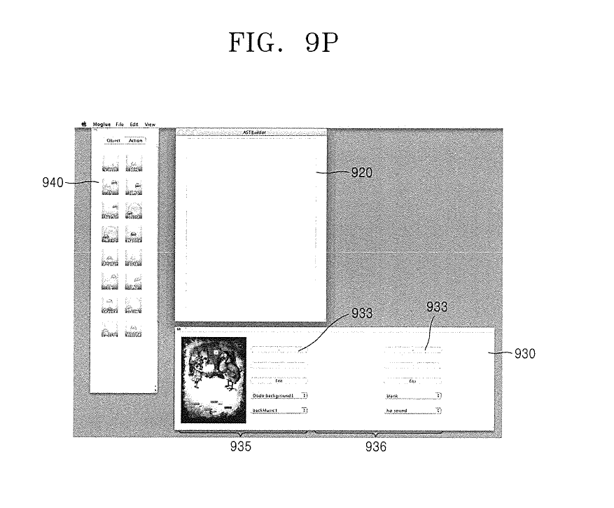

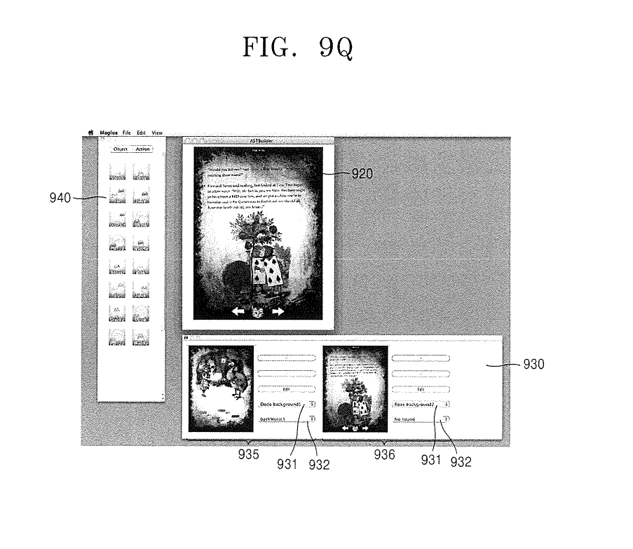

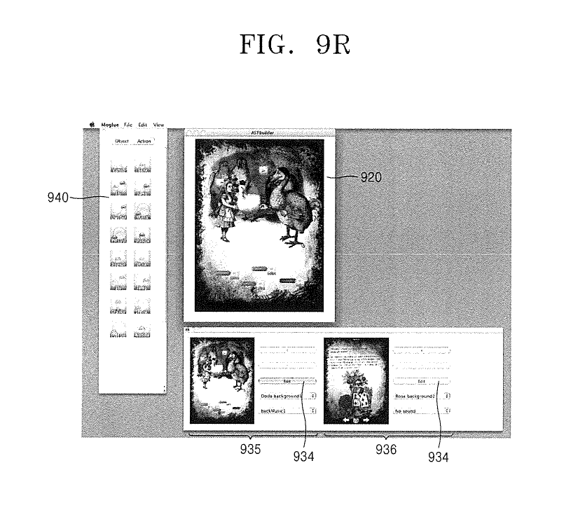

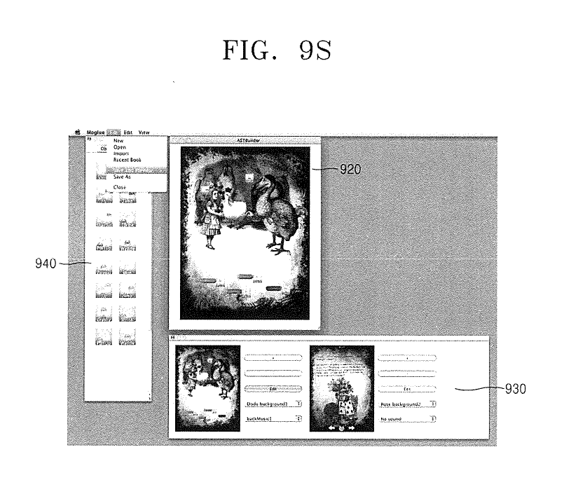

FIGS. 9A through 9S illustrate execution screens of the interactive electronic document creating application to perform the operations in the creation of the interactive electronic document in FIG. 8.

First, as illustrated in FIG. 9A, a user starts creation of an interactive electronic document on an empty screen including few basic objects. In more detail, a basic screen of the interactive electronic document creating application includes an object display unit 910, a page editing unit 920, and a page list display unit 930. Here, the object display unit 910 displays a plurality of objects that the user may select. The page editing unit 920 displays a page that is currently edited. The page list display unit 930 displays a preview of each of generated pages. Although not illustrated in FIG. 9A, the basic screen of the interactive electronic document creating application may further include an action and status display unit 940 (refer to FIG. 9J). That is, when the user presses an object display button 910a on a screen, the object display unit 910 is displayed, and when the user presses an action and status display unit 940a on the screen, the action and status display unit 940 (refer to FIG. 9J) may be displayed. However, one or more embodiments of the present invention are not limited thereto, and thus the object display unit 910 and the action and status display unit 940 (refer to FIG. 9J) may be formed and displayed as separate menus.

Next, as illustrated in FIG. 9B, the user selects a background of the page that is being created. In more detail, the page list display unit 930 displays a background selecting unit 931 for selecting a background of each page. Then, the user may select a desired background among backgrounds that are displayed on the background selecting unit 931. Although the background selecting unit 931 shown in FIG. 9B is in the form of a select box, the one or more embodiments of the present invention are not limited thereto and thus the form of the background selecting unit 931 may vary.

FIG. 9C illustrates an example in which a background selected in FIG. 9B is displayed on the page editing unit 920.

Next, as illustrated in FIG. 9D, the user may select background music of the page that is being created. In more detail, the page list display unit 930 may display a background music selecting unit 932 to select background music of each page, and the user may select desired background music from among a plurality of pieces of background music displayed on the background music selecting unit 932. Although the background music selecting unit 932 shown in FIG. 9D is in the form of a select box, the one or more embodiments of the present invention are not limited thereto, and thus, the form of the background music selecting unit 932 may vary.

As described above, after the background and the background music of the created page are selected, the user selects and edits an object to be disposed on the page. This will now be described in detail.

FIGS. 9E and 9F illustrate a procedure in which the user selects an Alice icon 911 displayed on the object display unit 910 and disposes the Alice icon 911 on the page editing unit 920. That is, as illustrated in FIG. 9E, the user drags the Alice icon 911 displayed the object display unit 910, and as illustrated in FIG. 9F, the user drops the user drops the Alice icon 911 to a desired position on the page editing unit 920, so to that an object is disposed at the desired position on the page. By manipulating the Alice icon 911, an Alice character 921 is created at the desired position on the page editing unit 920.

FIGS. 9G and 9H illustrate a procedure in which the user selects a do-do bird icon 912 displayed on the object display unit 910 and disposes the do-do bird icon 912 on the page editing unit 920. That is, as illustrated in FIG. 9G, the user drags the do-do bird icon 912 displayed the object display unit 910, and as illustrated in FIG. 9H, the user drops the do-do bird icon 912 to a desired position on the page editing unit 920, so that an object is disposed at the desired position on the page. By manipulating the do-do bird icon 912, a do-do bird character 922 is created at the desired position on the page editing unit 920.

FIG. 9I illustrates a procedure in which the user selects a pill icon 913 displayed on the object display unit 910 and disposes the pill icon 913 on the page editing unit 920. That is, the user drags the pill icon 913 displayed the object display unit 910, and drops the pill icon 913 to a desired position on the page editing unit 920, so that an object is disposed at the desired position on the page. By manipulating the pill icon 913, a pill object 923 is created at the desired position on the page editing unit 920. Here, as illustrated in FIG. 9I, a plurality of the same objects may be disposed on the page.

As described above, after the objects to be disposed on the page are selected and edited, the user selects and edits actions and statuses to be applied to the objects, respectively. This will now be described in detail.

FIG. 9J illustrates a procedure in which the user selects a gravity icon 941 displayed on the action and status display unit 940, and applies the gravity icon 941 to the pill object 923 disposed on the page editing unit 920. That is, the user drags the gravity icon 941 displayed on the action and status display unit 940, and drops the gravity icon 941 to the pill objects 923 disposed on the page editing unit 920, so that a gravity action is applied to the pill objects 923 on the page editing unit 920.

FIGS. 9K and 9L illustrate a procedure in which the user selects a jump icon 942 displayed on the action and status display unit 940, and applies the jump icon 942 to the Alice character 921 disposed on the page editing unit 920. That is, as illustrated in FIG. 9K, the user drags the jump icon 942 displayed on the action and status display unit 940, and as illustrated in FIG. 9L, the user drops the jump icon 942 to the Alice character 921 on the page editing unit 920, so that the user applies a desired action to a desired object on the page. By manipulating the jump icon 942, a jump action is applied to the Alice character 921 on the page editing unit 920.

FIGS. 9M and 9N illustrate a procedure in which the user selects a waddle icon 943 displayed on the action and status display unit 940, and applies the waddle icon 943 to the do-do bird character 922 disposed on the page editing unit 920. That is, as illustrated in FIG. 9M, the user drags the waddle icon 943 displayed on the action and status display unit 940, and as illustrated in FIG. 9N, the user drops the waddle icon 943 to the do-do bird character 922 on the page editing unit 920, so that the user applies a desired action to a desired object on the page. By manipulating the waddle icon 943, a waddle action is applied to the do-do bird character 922 on the page editing unit 920.

In addition, the user may import objects, actions, or statuses from an external file. That is, as illustrated in FIG. 90 in which a file titled whiterosel.png is highlighted on a screen, the user may import a predetermined file to a document. An object that is imported by the user may be included in a package such as a PSD.

Next, as illustrated in FIG. 9P, after the user completes the creation of the page, the user may create a new page. For example, when the user presses a page addition button 933 displayed on the page list display unit 930, as illustrated in FIG. 9P, a new page is displayed on the page editing unit 920.

Here, the page list display unit 930 may display a page list showing pages that have been created so far. That is, the page list display unit 930 may include separate page display units 935 and 936 in which the pages that have been created so far are simply displayed. When the user clicks the separate page display units 935 and 936, pages that correspond to the separate page display units 935 and 936 may be displayed on the page editing unit 920.

Next, as illustrated in FIG. 9O, a background and background music may be selected for the new page. The separate page display units 935 and 936 of the page list display unit 930 may display the background selecting unit 931 and the background music selecting unit 932 to select a background and background music for each page, and then the user may select a desired background and background music from among backgrounds and a plurality of pieces of background music which are displayed on the background selecting unit 931 and the background music selecting unit 932. FIG. 9Q illustrates an example in which a background selected for the new page is displayed on the page editing unit 920.

As illustrated in FIG. 9R, the user may presses an edition button 934 of one of the separate page display units 935 and 936 of the page list display unit 930, so that the user may select a page to be displayed on the page editing unit 920 and then to be edited. FIG. 9R illustrates an example in which, while the edition button 934 of the separate page display unit 935 is pressed, a page corresponding to the separate page display unit 935 is displayed on the page editing unit 920.

Lastly, as illustrated in FIG. 9S, the user may store edited pages and may also preview edited pages.

As described above, an interactive electronic document may be simply created by applying a simple and intuitive user interface thereto, so that anybody may rapidly and easily create and use an interactive electronic document. Also, user input signals that are generated in the interactive electronic document creating procedure are stored and analyzed to recognize a user action pattern, so that it is possible to easily create user-customized interactive electronic documents.

Hereinafter, the interactive electronic document reading system 1200, and a method of controlling the interactive electronic document reading system 1200 will be described.

First, as illustrated in FIG. 5, the interactive electronic document reading system 1200 includes one or more interactive electronic document readers 1201, the application server 1300 connected to the interactive electronic document readers 1201, and the communication network 1400 connecting the interactive electronic document readers 1201 and the application server 1300. Here, the interactive electronic document reader 1201 includes the same features as those of well known electronic document readers, and is characterized in further including a log storage unit (not shown). The log storage unit (not shown), in response to a control by a control unit (not shown), stores an interactive electronic document reading log in a DB (not shown). Here, the interactive electronic document reading log may indicate a record of various types of input signals that are input by the user while an interactive electronic document is being read.

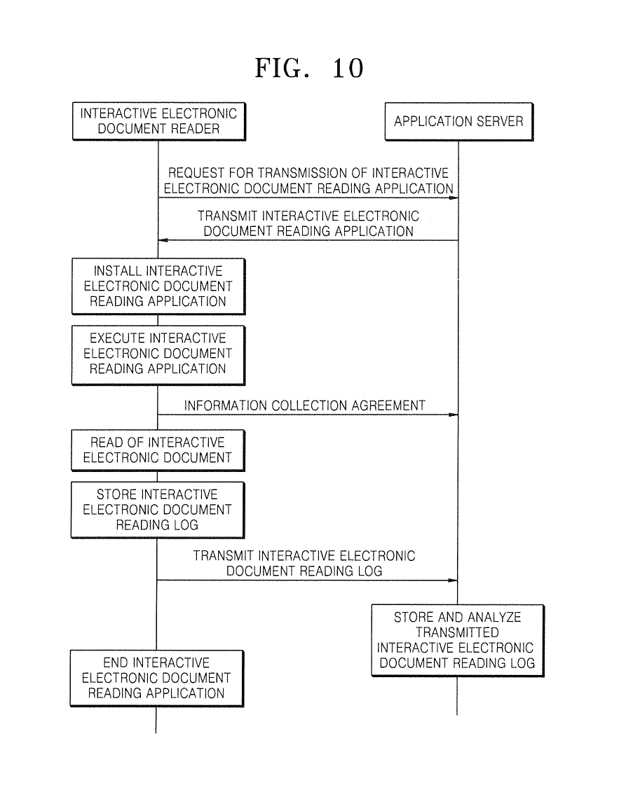

FIG. 10 is a flowchart of the method of controlling the interactive electronic document reading system 1200, according to an embodiment of the present invention. The method of controlling the interactive electronic document reading system 1200 will be described with reference to FIGS. 5 and 10.

First, a user who attempts to read an interactive electronic document by using the interactive electronic document reading system 1200 transmits a transmission request for an interactive electronic document reading application to the application server 1300 via the interactive electronic document reader 1201 such as a tablet PC or a smart phone. Here, although not illustrated, the user who attempts to read the interactive electronic document may undergo a user authentication procedure before he transmits the transmission request.

In this manner, when the transmission request for the interactive electronic document reading application is transmitted from the interactive electronic document reader 1201 to the application server 1300, the application server 1300 may determine whether the transmission request satisfies a predetermined condition, and if satisfied, the application server 1300 may transmit the interactive electronic document reading application to the interactive electronic document reader 1201.

Next, the interactive electronic document reader 1201 receives and executes the interactive electronic document reading application, so that the interactive electronic document reading application is installed.

After the interactive electronic document reading application is installed, the user who attempts to read the interactive electronic document executes the interactive electronic document reading application on a user's interactive electronic document reader 1201. By doing so, an interactive electronic document reading program is driven in the interactive electronic document reader 1201.

The user who executed the interactive electronic document reading application on the interactive electronic document reader 1201 may transmit an information collection agreement signal to the application server 1300. The information collection agreement signal may include an agreement that the user agrees to provide an interactive electronic document reading log, which is generated in an interactive electronic document reading procedure, to the application server 1300. However, the information collection agreement signal is not necessarily required, so that only a user who wants to provide the interactive electronic document reading log may transmit the information collection agreement signal.

Next, the user executes the interactive electronic document reading application on the interactive electronic document reader 1201 and actually reads the interactive electronic document.

Next, when the user completes the reading of the interactive electronic document, the interactive electronic document reader 1201 may store the interactive electronic document reading log that is the record of various types of input signals that are input from the user in the interactive electronic document reading procedure.

Next, the stored interactive electronic document reading log may be transmitted to the application server 1300. The transmission of the interactive electronic document reading log may be performed only in the interactive electronic document reader 1201 that has transmitted the information collection agreement signal to the application server 1300.

After the interactive electronic document reading log is transmitted to the application server 1300, the interactive electronic document reading application may be ended, and thus the interactive electronic document reading procedure may be completed.

The interactive electronic document reading log that is transmitted to the application server 1300 may be stored in and analyzed by the application server 1300. That is, the application server 1300 may store and analyze user input signals that are included in the interactive electronic document reading log and are generated in the interactive electronic document reading procedure. By doing so, the application server 1300 may analyze an input pattern of each user, an each user's preference for objects, actions, and statuses, or the like. The user input signals that are included in the interactive electronic document reading log and are generated in the interactive electronic document reading procedure may include coordinates of a user-touched position on the interactive electronic document reader 1201, an object disposed at the user-touched position, actions and statuses which are performed when the object is executed, a number of a page read by a user, a background and background music, a time period in which the user works on each page, and the like.

As described above, the user input signals that are generated in the interactive electronic document reading procedure are stored and analyzed to recognize a user action pattern, so that it is possible to easily create user-customized interactive electronic documents.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The one or more embodiments of the present invention may be applied to the interactive electronic document creating device that may easily and conveniently create an interactive electronic document to be used like a book by having information such as letters or images recorded on an electronic medium, may store a user input signal generated in the creation and use of the interactive electronic document, and may is recognize a user action pattern by analyzing the user input signal, the system including the interactive electronic document creating device, the method of controlling the system, the interactive electronic document reading system, and the method of controlling the interactive electronic document reading system.

1. An interactive electronic document creating device for creating an interactive electronic document, the interactive electronic document creating device comprising:
a user interface unit for receiving a user input signal;
an object adding unit for adding an object to the interactive electronic document;
an action and status adding unit for adding an action and a status to the object of the interactive electronic document; and
a control unit for controlling the addition of the object, the addition of the action, and the addition of the status with respect to the interactive electronic document, in response to an input signal received by the user interface unit.

2. The interactive electronic document creating device of claim 1, further comprising a database for storing information of the object that is added to the interactive electronic document, and the action and the status which are added to the object.

3. The interactive electronic document creating device of claim 2, further comprising a page adding unit for controlling addition of a new page to the interactive electronic document.

4. The interactive electronic document creating device of claim 3, wherein the database further stores at least one of a consecutive number of a page generated by the page adding unit, previous and next pages of the page, information of an object comprised in the page, and an action and a status which are applied to the object comprised in the page.

5. The interactive electronic document creating device of claim 1, wherein the interactive electronic document creating device imports the object, the action, and the status from a separate file.

6. The interactive electronic document creating device of claim 1, further comprising a preview generating unit for previously checking the object disposed in the interactive electronic document, and the action or the status which is applied to the object.

7. The interactive electronic document creating device of claim 1, further comprising a log storage unit for storing an interactive electronic document creation log.

8. The interactive electronic document creating device of claim 7, wherein the interactive electronic document creation log indicates a record of various types of input signals that are input to the user interface unit while the interactive electronic document is being created.

9. The interactive electronic document creating device of claim 7, wherein is the interactive electronic document creation log comprises at least one of the number of generated pages, a creation time of each of the pages, the number of times that each object, each action, and each status are selected, and a method of adding each object, each action, and each status.

10. The interactive electronic document creating device of claim 1, wherein the control unit controls the object to be added to the interactive electronic document, in response to a drag-and-drop signal or a touch-and-drag signal which is received by the user interface unit.

11. The interactive electronic document creating device of claim 1, wherein the control unit controls the action and the status to be added to the object, in response to a drag-and-drop signal or a touch-and-drag signal which is received by the user interface unit.

12. The interactive electronic document creating device of claim 1, wherein the control unit controls a size and a position of the object in the interactive electronic document.

13. The interactive electronic document creating device of claim 1, wherein the interactive electronic document creating device comprises at least one of a tablet personal computer (tablet PC), a mobile telephone, a smart phone, a telephone, a PC, and a personal digital assistant (PDA).

14. A system comprising:
an interactive electronic document creating device having a structure of claim 1; and
an application server that is connected to the interactive electronic document creating device via a communication network and that receives and stores an interactive electronic document creation log stored in the interactive electronic document creating device.

15. The system of claim 14, wherein the interactive electronic document creation log indicates a record of various types of input signals that are input to the user interface unit while the interactive electronic document is being created.

16. The system of claim 14, wherein the interactive electronic document creation log comprises at least one of the number of generated pages, a creation time of each of the pages, the number of times that each object, each action, and each status are selected, and a method of adding each object, each action, and each status.

17. The system of claim 14, wherein the application server analyzes a user's input pattern and a user's preference with respect to the object, the action, and the status.

18. A method of controlling an interactive electronic document creating system, the method comprising:
executing an interactive electronic document creating application;
creating an interactive electronic document by using the interactive electronic document creating application; and
storing an interactive electronic document creation log that is generated while the interactive electronic document is being created.

19. The method of claim 18, wherein the creating of the interactive electronic document comprises:
adding an object to the interactive electronic document, in response to a received user input signal;
adding an action and a status to the object, in response to a received user input signal; and
storing the object, the action, and the status.

20. The method of claim 19, wherein the object is added to the interactive electronic document, in response to a drag-and-drop signal or a touch-and-drag signal which is received by a user interface unit.

21. The method of claim 19, wherein the action and the status are added to the object, in response to a drag-and-drop signal or a touch-and-drag signal which is received by a user interface unit.

22. The method of claim 18, wherein the interactive electronic document creation log indicates a record of various types of input signals that are input to the user interface unit while the interactive electronic document is being created.

23. The method of claim 18, wherein the interactive electronic document creation log comprises at least one of the number of generated pages, a creation time of each of the pages, the number of times that each object, each action, and each status are selected, and a method of adding each object, each action, and each status.

24. The method of claim 18, further comprising transmitting the interactive electronic document creation log to an application server.

25. The method of claim 24, further comprising analyzing, by the application server, a user's input pattern and a user's preference with respect to the object, the action, and the status from the interactive electronic document creation log.

26. An interactive electronic document reading system comprising:
an interactive electronic document reader for reading a created interactive electronic document, and storing an interactive electronic document reading log that is generated in the reading; and
an application server that is connected to the interactive electronic document to reader via a communication network and receives and stores the interactive electronic document reading log stored in the interactive electronic document reader.

27. The interactive electronic document reading system of claim 26, wherein the interactive electronic document reading log indicates a record of various types of input signals that are input to a user interface unit while the interactive electronic document is being read.

28. The interactive electronic document reading system of claim 26, wherein the interactive electronic document reading log comprises at least one of coordinates of a user-touched position on the interactive electronic document reader, an object disposed at the user-touched position, actions and statuses which are performed when the object is executed, a number of a read page, a background and background music, and a time period in which a user works on each page.

29. The interactive electronic document reading system of claim 26, wherein the application server analyzes a user's input pattern and a user's preference with respect to an object, an action, and a status from the interactive electronic document reading log.

30. A method of controlling an interactive electronic document reading system, the method comprising:
executing an interactive electronic document reading application;
reading an interactive electronic document by using the interactive electronic document reading application; and
storing an interactive electronic document reading log that is generated while the interactive electronic document is being read.

31. The method of claim 30, wherein the interactive electronic document reading log indicates a record of various types of input signals that are input to a user interface unit while the interactive electronic document is being read.

32. The method of claim 30, wherein the interactive electronic document reading log comprises at least one of coordinates of a user-touched position on an interactive electronic document reader, an object disposed at the user-touched position, actions and statuses which are performed when the object is executed, a number of a read page, a background and background music, and a time period in which a user works on each page.

33. The method of claim 30, further comprising transmitting the interactive electronic document reading log to an application server.

34. The method of claim 33, further comprising analyzing, by the application server, a user's input pattern and a user's preference with respect to an object, an action, and a status from the interactive electronic document reading log.
